(19) United States
(12) Patent Application Publication
(10) Pub. No.: US 2023/0360425 A1
(43) Pub. Date: Nov. 9, 2023

(54) ESTIMATION MODEL FOR INTERACTION DETECTION BY A DEVICE

(71) Applicant: Samsung Electronics Co., Ltd., Suwon-si (KR)

(72) Inventors: Dongfang Zhao, San Diego, CA (US); Yangwen Liang, San Diego, CA (US); Shuangquan Wang, San Diego, CA (US); Kee-Bong Song, San Diego, CA (US)

(21) Appl. No.: 18/298,128

(22) Filed: Apr. 10, 2023

Related U.S. Application Data
(60) Provisional application No. 63/337,918, filed on May 3, 2022.

(51) Int. Cl. G06V 40/10; G06V 10/77; G06V 10/82; G06T 19/00

(52) U.S. Cl. CPC G06V 40/11; G06V 10/7715; G06V 10/82; G06T 19/006

(57) ABSTRACT

A method and device are disclosed for estimating an interaction with the device. The method includes configuring a first token and a second token of an estimation model according to first features of a 3D object, applying a first weight to the first token to produce a first-weighted input token and applying a second weight that is different from the first weight to the second token to produce a second-weighted input token, and generating, by a first encoder layer of an estimation-model encoder of the estimation model, an output token based on the first-weighted input token and the second-weighted input token. The method may include receiving, at a 2D feature extraction model, the first features from a backbone, extracting, by the 2D feature extraction model, second features including 2D features, and receiving, at the estimation-model encoder, data generated based on the 2D features.

### CROSS-REFERENCE TO RELATED APPLICATION

This application claims the priority benefit under 35 U.S.C. § 119(e) of U.S. Provisional Application No. 63/337,918, filed on May 3, 2022, the disclosure of which is incorporated by reference in its entirety as if fully set forth herein.

### TECHNICAL FIELD

The disclosure generally relates to machine learning. More particularly, the subject matter disclosed herein relates to improvements to the detection of interactions with a device using machine learning.

### SUMMARY

Devices (e.g., virtual reality (VR) devices, augmented reality (AR) devices, communications devices, medical devices, appliances, machines, etc.) may be configured to make determinations about interactions with the devices. For example, a VR or AR device may be configured to detect human-device interactions, such as specific hand gestures (or hand poses). The device may use information associated with the interactions to perform an operation on the device (e.g., changing a setting on the device). Similarly, any device may be configured to estimate different interactions with the device and perform operations associated with the estimated interactions.

To solve the problem of accurately detecting interactions with a device, a variety of machine learning (ML) models have been applied. For example, convolutional neural network- (CNN-) based models and transformer-based models have been applied.

One issue with the above approaches is that the accuracy of estimating interactions (e.g., hand poses) may be reduced in some situations due to self-occlusion, camera distortion, three-dimensional (3D) ambiguity of projection, etc. For example, self-occlusion may commonly occur in hand-pose estimation, where one part of a user's hand may be occluded by (e.g., covered by) another part of the user's hand from the viewpoint of the device. Thus, the accuracy of estimating the hand pose and/or distinguishing between similar hand gestures may be reduced.

To overcome these issues, systems and methods are described herein for improving an accuracy of a device to estimate interactions with the device by using a machine learning model with a pre-sharing mechanism, two-dimensional (2D) feature map extraction, and/or a dynamic-mask mechanism.

The above approaches improve on previous methods because accuracy may be improved, and better performance may be achieved in mobile devices having limited computing resources.

Some embodiments of the present disclosure provide for a method for using an estimation model having 2D feature extraction between a backbone and an estimation-model encoder.

Some embodiments of the present disclosure provide for a method for using an estimation model having pre-sharing weights in an encoder layer of a Bidirectional Encoder Representations from Transformers (BERT) encoder of the estimation-model encoder.

Some embodiments of the present disclosure provide for a method for using an estimation model having 3D hand joints and mesh points estimated by applying camera intrinsic parameters to one or more BERT encoders, along with hand tokens from a previous BERT encoder, as inputs to the one or more BERT encoders. For example, camera intrinsic parameters may be applied, along with hand tokens from a fourth BERT encoder, as inputs to a fifth BERT encoder. While embodiments involving hands and hand joints are discussed herein, it will be appreciated that the embodiments and techniques described are applicable, without limit, to any mesh or model, including those of various other body parts.

Some embodiments of the present disclosure provide for a method for using an estimation model with data generated based on 2D feature map.

Some embodiments of the present disclosure provide for a method for using an estimation model with a dynamic-mask mechanism.

Some embodiments of the present disclosure provide for a method for using an estimation model trained with a data set generated based on 2D-image rotation and rescaling that is projected to 3D in an augmentation process.

Some embodiments of the present disclosure provide for a method for using an estimation model trained with two optimizers.

Some embodiments of the present disclosure provide for a method for using an estimation model having BERT encoders with more than four (e.g., twelve) encoder layers.

Some embodiments of the present disclosure provide for a method for using an estimation model having hyper-parameters that are mobile-friendly by using fewer transformers or smaller transformers in each BERT encoder than would be used in a large device with more computing resources.

Some embodiments of the present disclosure provide for a device on which an estimation model may be implemented.

According to some embodiments of the present disclosure, a method of estimating an interaction with a device includes configuring a first token and a second token of an estimation model according to one or more first features of a 3-dimensional (3D) object, applying a first weight to the first token to produce a first-weighted input token and applying a second weight that is different from the first weight to the second token to produce a second-weighted input token, and generating, by a first encoder layer of an estimation-model encoder of the estimation model, an output token based on the first-weighted input token and the second-weighted input token.

The method may further include receiving, at a backbone of the estimation model, input data corresponding to the interaction with the device, extracting, by the backbone, the one or more first features from the input data, receiving, at a two-dimensional (2D) feature extraction model, the one or more first features from the backbone, extracting, by the 2D feature extraction model, one or more second features associated with the one or more first features, the one or more second features including one or more 2D features, receiving, at the estimation-model encoder, data generated based on the one or more 2D features, generating, by the estimation model, an estimated output based on the output token and the data generated based on the one or more 2D features, and performing an operation based on the estimated output.

The data generated based on the one or more 2D features may include an attention mask.

The first encoder layer of the estimation-model encoder may correspond to a first BERT encoder of the estimation-model encoder, and the method may further include concatenating a token, associated with an output of the first BERT encoder, with at least one of camera intrinsic-parameter data, three-dimensional (3D) hand-wrist data, or bone-length data to generate concatenated data, and receiving the concatenated data at a second BERT encoder.

The first BERT encoder and the second BERT encoder may be included in a chain of BERT encoders, the first BERT encoder and the second BERT encoder may be separated by at least three BERT encoders of the chain of BERT encoders, and the chain of BERT encoders may include at least one BERT encoder having more than four encoder layers.

A data set used to train the estimation model may be generated based on two-dimensional (2D) image rotation and rescaling that is projected to three dimensions (3D) in an augmentation process, and a backbone of the estimation model may be trained using two optimizers.

The device may be a mobile device, the interaction may be a hand pose, and the estimation model may include hyperparameters including at least one of an input feature dimension that is about equal to 1003/256/128/32 for estimating 195 hand-mesh points, an input feature dimension that is about equal to 2029/256/128/64/32/16 for estimating 21 hand joints, a hidden feature dimension that is about equal to 512/128/64/16 (4H, 4L) for estimating 195 hand-mesh points, or a hidden feature dimension that is about equal to 512/256/128/64/32/16 (4H, (1, 1, 1, 2, 2, 2)L) for estimating 21 hand joints.

The method may further include generating a 3D scene including a visual representation of the 3D object, and updating the visual representation of the 3D object based on the output token.

According to other embodiments of the present disclosure, a method of estimating an interaction with a device includes receiving, at a two-dimensional (2D) feature extraction model of an estimation model, one or more first features corresponding to input data associated with an interaction with the device, extracting, by the 2D feature extraction model, one or more second features associated with the one or more first features, the one or more second features including one or more 2D features, generating, by the 2D feature extraction model, data based on the one or more 2D features, and providing the data to an estimation-model encoder of the estimation model.

The method may further include receiving, at a backbone of the estimation model, the input data, generating, by the backbone, the one or more first features based on the input data, associating a first token and a second token of the estimation model with the one or more first features, applying a first weight to the first token to produce a first-weighted input token and applying a second weight that is different from the first weight to the second token to produce a second-weighted input token, calculating, by a first encoder layer of the estimation-model encoder, an output token based on receiving the first-weighted input token and the second-weighted input token as inputs, and generating, by the estimation model, an estimated output based on the output token and the data generated based on the one or more 2D features, and performing an operation based on the estimated output.

The data generated based on the one or more 2D features may include an attention mask.

The estimation-model encoder may include a first BERT encoder including a first encoder layer, and the method may further include concatenating a token, corresponding to an output of the first BERT encoder, with at least one of camera intrinsic-parameter data, three-dimensional (3D) hand-wrist data, or bone-length data to generate concatenated data, and receiving the concatenated data at a second BERT encoder.

The first BERT encoder and the second BERT encoder may be included in a chain of BERT encoders, the first BERT encoder and the second BERT encoder may be separated by at least three BERT encoders of the chain of BERT encoders, and the chain of BERT encoder may include at least one BERT encoder having more than four encoder layers.

A data set used to train the estimation model may be generated based on 2D-image rotation and rescaling that is projected to three dimensions (3D) in an augmentation process, and a backbone of the estimation model may be trained using two optimizers.

The device may be a mobile device, the interaction may be a hand pose, and the estimation model may include hyperparameters including at least one of an input feature dimension that is about equal to 1003/256/128/32 for estimating 195 hand-mesh points, an input feature dimension that is about equal to 2029/256/128/64/32/16 for estimating 21 hand joints, a hidden feature dimension that is about equal to 512/128/64/16 (4H, 4L) for estimating 195 hand-mesh points, or a hidden feature dimension that is about equal to 512/256/128/64/32/16 (4H, (1, 1, 1, 2, 2, 2)L) for estimating 21 hand joints.

The method may further include calculating, by a first encoder layer of the estimation-model encoder, an output token, generating a 3D scene including a visual representation of the interaction with the device, and updating the visual representation of the interaction with the device based on the output token.

According to other embodiments of the present disclosure, a device configured to estimate an interaction with the device includes a memory, and a processor communicably coupled to the memory, wherein the processor is configured to receive, at a two-dimensional (2D) feature extraction model of an estimation model, one or more first features corresponding to input data associated with an interaction with the device, generate, by the 2D feature extraction model, one or more second features based on the one or more first features, the one or more second features including one or more 2D features, and send, by the 2D feature extraction model, data generated based on the one or more 2D features to an estimation-model encoder of the estimation model.

The processor may be configured to receive, at a backbone of the estimation model, the input data, generate, by the backbone, the one or more first features based on the input data, associate a first token and a second token of the estimation model with the one or more first features, apply a first weight to the first token to produce a first-weighted input token and applying a second weight that is different from the first weight to the second token to produce a second-weighted input token, calculate, by a first encoder layer of the estimation-model encoder, an output token based on receiving the first-weighted input token and the second-weighted input token as inputs, generate, by the estimation model, an estimated output based on the output token and the data generated based on the one or more 2D features, and perform an operation based on the estimated output.

The data generated based on the one or more 2D features may include an attention mask.

The estimation-model encoder may include a first BERT encoder including a first encoder layer, and the processor may be configured to concatenate a token, corresponding to an output of the first BERT encoder, with at least one of camera intrinsic-parameter data, three-dimensional (3D) hand-wrist data, or bone-length data to generate concatenated data, and receive the concatenated data at a second BERT encoder.

### BRIEF DESCRIPTION OF THE DRAWING

In the following section, the aspects of the subject matter disclosed herein will be described with reference to exemplary embodiments illustrated in the figures, in which:

FIG. 1 is block diagram depicting a system including an estimation model, according to some embodiments of the present disclosure.

FIG. 2A is a block diagram depicting 2D feature map extraction, according to some embodiments of the present disclosure.

FIG. 2B is a block diagram depicting a 2D feature extraction model, according to some embodiments of the present disclosure.

FIG. 3 is a block diagram depicting a structure of an estimation-model encoder of the estimation model, according to some embodiments of the present disclosure.

FIG. 4 is a block diagram depicting a structure of a BERT encoder of the estimation-model encoder, according to some embodiments of the present disclosure.

FIG. 5A is a block diagram depicting a structure of an encoder layer of the BERT encoder with a pre-sharing weight mechanism, according to some embodiments of the present disclosure.

FIG. 5B is a diagram depicting full sharing with a same weight applied to different input tokens of the encoder layer of the BERT encoder, according to some embodiments of the present disclosure.

FIG. 5C is a diagram depicting pre-aggregation sharing with different weights applied to different input tokens of the encoder layer of the BERT encoder, according to some embodiments of the present disclosure.

FIG. 5D is a diagram depicting hand joints and a hand mesh, according to some embodiments of the present disclosure.

FIG. 5E is a block diagram depicting a dynamic mask mechanism, according to some embodiments of the present disclosure.

FIG. 6 is a block diagram of an electronic device in a network environment, according to some embodiments of the present disclosure.

FIG. 7A is a flowchart depicting example operations of a method of estimating an interaction with a device, according to some embodiments of the present disclosure.

FIG. 7B is a flowchart depicting example operations of a method of estimating an interaction with a device, according to some embodiments of the present disclosure.

FIG. 7C is a flowchart depicting example operations of a method of estimating an interaction with a device, according to some embodiments of the present disclosure.

FIG. 8 is a flowchart depicting example operations of a method of estimating an interaction with a device, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

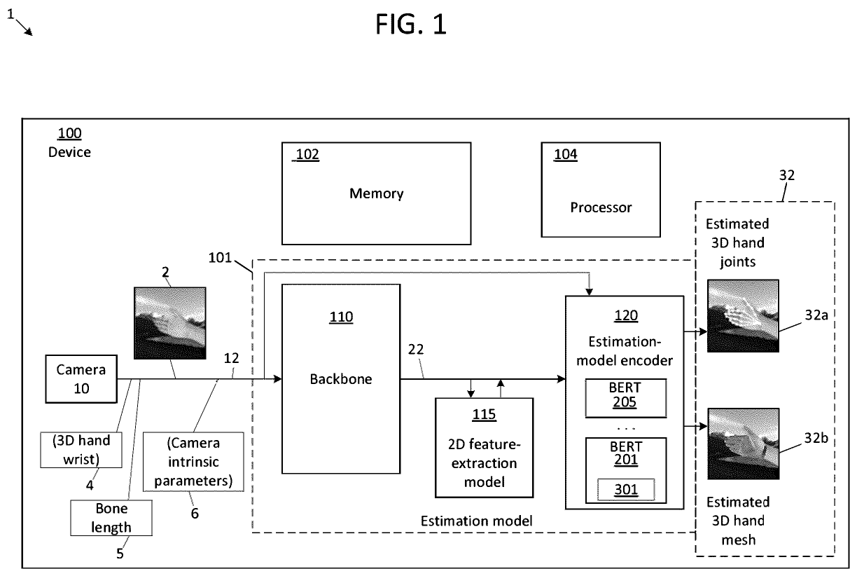

FIG. 1 is block diagram depicting a system including an estimation model, according to some embodiments of the present disclosure.

Aspects of embodiments of the present disclosure may be used in augmented reality (AR) or virtual reality (VR) devices for high-accuracy 3D hand-pose estimation from a single camera so as to provide hand pose information in human-device interaction processes. Aspects of embodiments of the present disclosure may provide for accurate hand-pose estimation including 21 hand joints and hand meshes in 3D from a single RGB image and in real-time for human-device interaction.

Referring to FIG. 1, a system 1 for estimating an interaction with a device 100 may involve determining a hand pose (e.g., a 3D hand pose) based on analyzing image data 2 (e.g., image data associated with a 2D image). The system 1 may include a camera 10 for capturing image data 2 associated with the interaction with the device 100. The system 1 may include a processor 104 (e.g., a processing circuit) communicably coupled with a memory 102. The processor 104 may include a central processing unit (CPU), a graphics processing unit (GPU), and/or a neural processing unit (NPU). The memory 102 may store weights and other data for processing input data 12 to generate estimated outputs 32 from an estimation model 101 (e.g., a hand-pose estimation model). The input data 12 may include the image data 2, 3D hand-wrist data 4, bone-length data 5 (e.g., bone length), and camera intrinsic-parameter data 6. For example, the camera intrinsic-parameter data 6 may include information that is intrinsic to the camera 10, such as the location of the camera, focal-length data, and/or the like. Although the present disclosure describes hand-pose estimation, it should be understood that the present disclosure is not limited thereto and that the present disclosure may be applied to estimating a variety of interactions with the device 100. For example, the present disclosure may be applied to estimating any part of, or an entirety of, any object that may interact with the device 100.

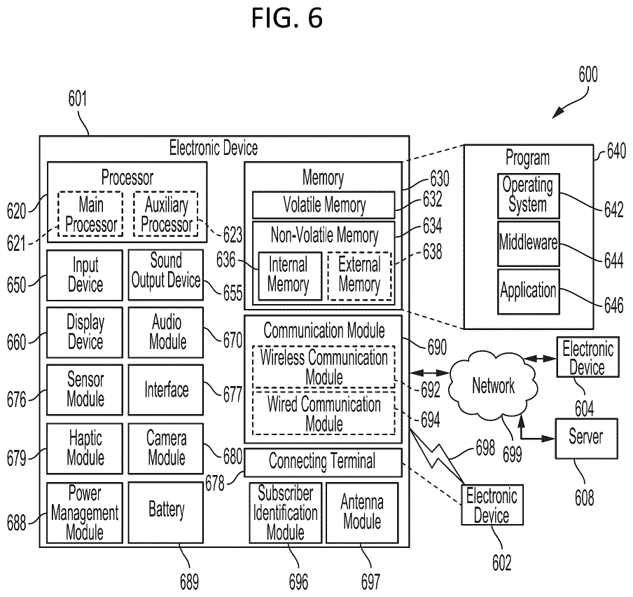

The device 100 may correspond to the electronic device 601 of FIG. 6. The camera 10 may correspond to the camera module 680 of FIG. 6. The processor 104 may correspond to the processor 620 of FIG. 6. The memory 102 may correspond to the memory 630 of FIG. 6.

Referring still to FIG. 1, the estimation model 101 may include a backbone 110, an estimation-model encoder 120, and/or a 2D feature-extraction model 115, all of which are discussed in further detail below. The estimation model 101 may include software components stored on the memory 102 and processed with the processor 104. A “backbone” as used herein refers to a neural network that has been previously trained in other tasks and, thus, has a demonstrated effectiveness for estimating (e.g., predicting) outputs based on a variety of inputs. Some examples of a “backbone” are CNN-based or transformer-based backbones, such as a visual attention network (VAN) or a high-resolution network (HRNet). The estimation-model encoder 120 may include one or more BERT encoders (e.g., a first BERT encoder 201 and a fifth BERT encoder 205). A “BERT encoder” as used herein refers to a machine learning structure that includes transformers to learn contextual relationships between inputs. Each BERT encoder may include one or more BERT encoder layers (e.g., a first encoder layer 301). An “encoder layer” (also referred to as a “BERT encoder layer” or a “transformer”) as used herein refers to an encoder layer having an attention mechanism, which uses tokens as a basic unit of input to learn and predict high-level information from all tokens based on the attention (or relevance) of each individual token compared with all tokens. An “attention mechanism” as used herein refers to a mechanism that enables a neural network to concentrate on some portions of input data while ignoring other portions of the input data. A “token” as used herein refers to a data structure used to represent one or more features extracted from input data, wherein the input data includes positional information.

The 2D feature-extraction model 115 may be located between the backbone 110 and the estimation-model encoder 120. The 2D feature-extraction model 115 may extract 2D features associated with the input data 12. The 2D feature-extraction model 115 may provide data generated based on the 2D features to the estimation-model encoder 120 to improve the accuracy of the estimation-model encoder 120, as is discussed in further detail below.

The estimation model 101 may process the input data 12 to generate an estimated output 32. The estimated output 32 may include a first estimation-model output 32a and/or a second estimation-model output 32b. For example, the first estimation-model output 32a may include an estimated 3D hand-joint output, and the second estimation-model output 32b may include an estimated 3D hand-mesh output. In some embodiments, the estimated output 32 may include 21 hand joints and/or a hand mesh with 778 vertices in 3D. The device 100 may use the estimated 3D hand-joint output to perform an operation associated with a gesture corresponding to the estimated 3D hand-joint output. The device 100 may use the estimated 3D hand-mesh output to present a user of the device with a virtual representation of the user's hand.

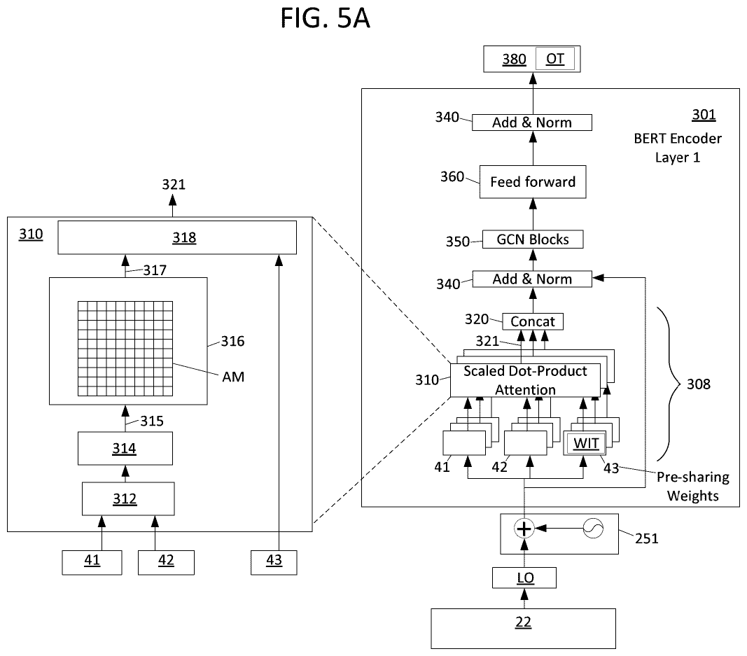

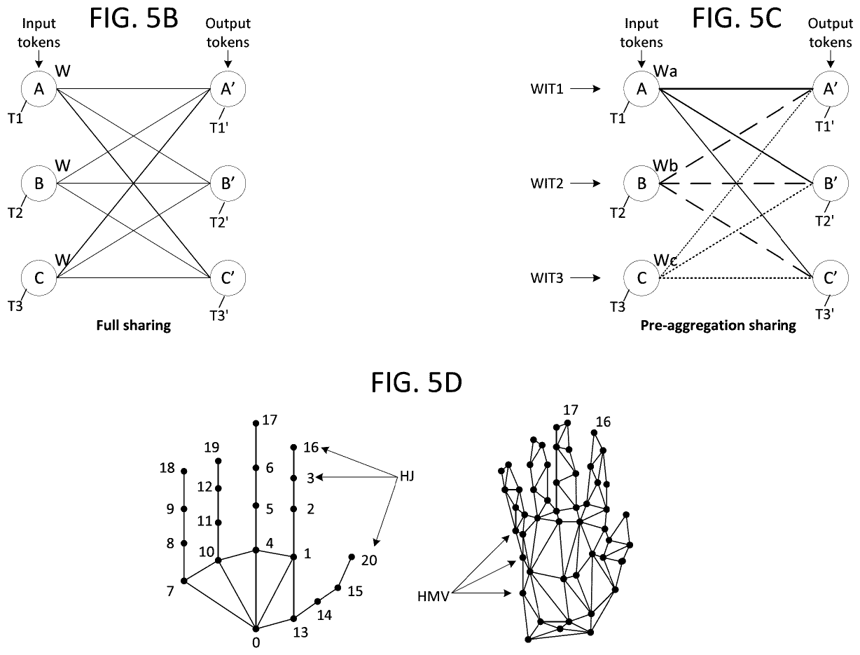

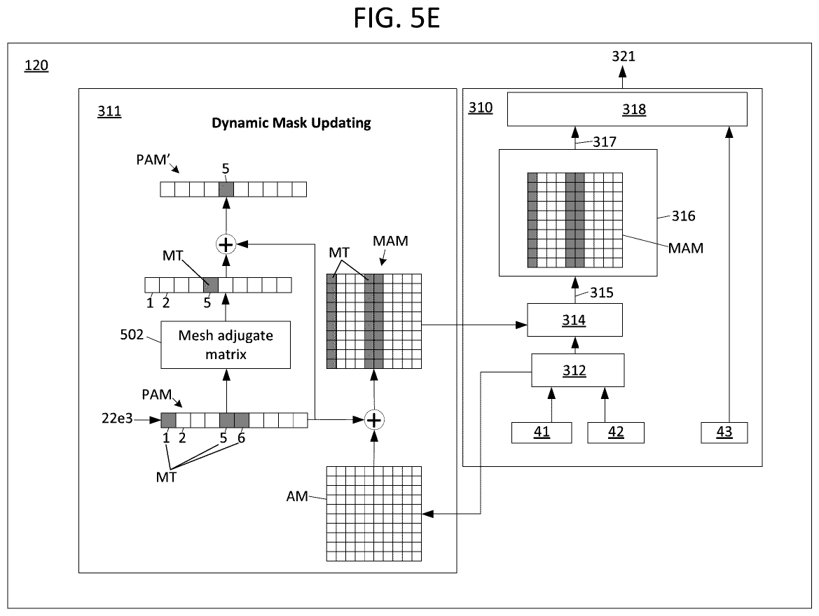

In some embodiments, the device 100 may generate a 3D scene including a visual representation of a 3D object (e.g., the estimated 3D hand-joint output and/or the estimated 3D hand-mesh output). The device 100 may update the visual representation of the 3D object based on an output token (see FIG. 5A and the corresponding description below).

In some embodiments, the estimation model 101 may be trained using two optimizers to improve accuracy. For example, the training optimizers may include Adam with weight decay (AdamW) and stochastic gradient descent with weight decay (SGDW). In some embodiments, the estimation model 101 may be trained with GPUs for AR and/or VR device applications.

In some embodiments, a data set used to train the estimation model 101 may be generated based on 2D-image rotation and rescaling that is projected to 3D in an augmentation process, which may improve the robustness of the estimation model 101. That is, the data set used for training may be generated using 3D-perspective hand-joint augmentation or 3D-perspective hand-mesh augmentation.

In some embodiments, the estimation model 101 may be configured to be mobile friendly by using parameters (e.g., hyper-parameters, including input feature dimensions and/or hidden feature dimensions) to provide real-time model performance (e.g., greater than 30 frames per second (FPS)) from limited computing resources. For example, each BERT encoder of the estimation-model encoder 120 in a mobile-friendly (or small model) design may include fewer transformers and/or smaller transformers than a large-model design, such that the small model may still achieve real-time performance with fewer computational resources.

For example, a first small-model version of an estimation model 101 may have the following parameters for estimating 195 hand-mesh points (or vertices). A backbone parameter size (in millions (M)) may be equal to about 4.10; an estimation-model encoder parameter size (M) may be equal to about 9.13; a total parameter size (M) may be equal to about 13.20; an input feature dimension may be equal to about 1003/256/128/32; a hidden feature dimension (head number, encoder layer number) may be equal to about 512/128/64/16 (4H, 4L); and a corresponding FPS may be equal to about 83 FPS.

A second small-model version of an estimation model 101 may have the following parameters for estimating 21 hand joints. A backbone parameter size (M) may be equal to about 4.10; an estimation-model encoder parameter size (M) may be equal to about 5.23; a total parameter size (M) may be equal to about 9.33; an input feature dimension may be equal to about 2029/256/128/64/32/16; a hidden feature dimension (head number, encoder layer number) may be equal to about 512/256/128/64/32/16 (4H, (1, 1, 1, 2, 2, 2)L); and a corresponding FPS may be equal to about 285 FPS.

In some embodiments, mobile-friendly versions of the estimation model 101 may have a reduced number of parameters and floating-point operations (FLOPs) by shrinking the number of encoder layers and applying a VAN instead of HRNet-w64 in a BERT encoder block, which enables high-accuracy hand-pose estimation in mobile devices in real time.

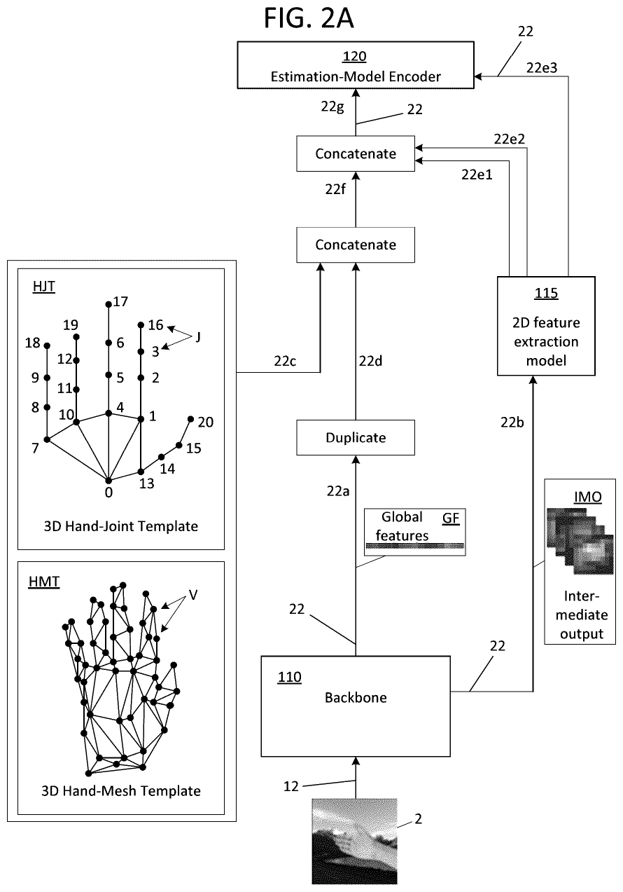

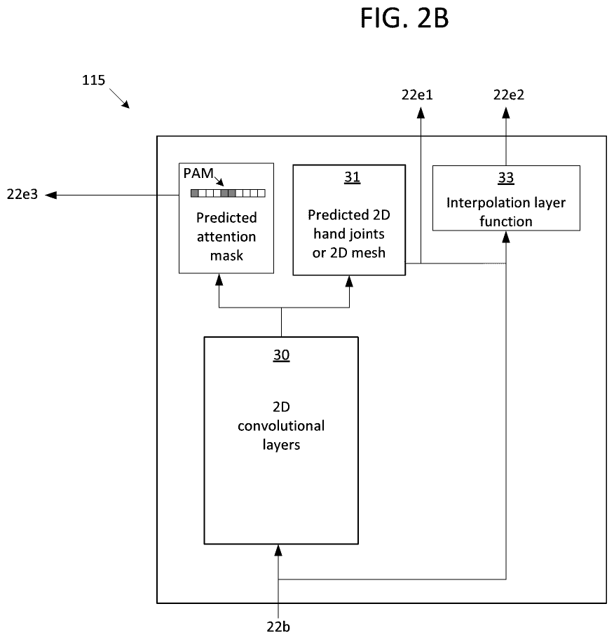

FIG. 2A is a block diagram depicting 2D feature map extraction, according to some embodiments of the present disclosure.

Referring to FIG. 2A, the backbone 110 may be configured to extract (e.g., to remove or to generate data based on) features from the input data 12. As discussed above, the input data 12 may include 2D-image data. One or more estimation-model-encoder input-preparation operations (e.g., reading or writing associated with data flows) 22a-g may be associated with the backbone output data 22. For example, global features GF from the backbone output data 22 may be duplicated at operation 22a. The backbone output data 22 (e.g., intermediate-output data IMO associated with the backbone output data 22) may be sent to the 2D feature-extraction model 115 at operation 22b. A 3D hand-joint template HJT and/or a 3D hand-mesh template HMT may be concatenated with the global features GF at operations 22c and 22d to associate one or more features from the backbone 110 with hand joints J and/or vertices V. As discussed in further detail below with respect to FIG. 2B, the 2D feature-extraction model 115 may extract 2D features from the intermediate-output data IMO and send data generated based on the 2D features to be concatenated with the global features GF and with the 3D hand-joint template HJT and/or the 3D hand-mesh template HMT at operations 22e1 and 22e2. The 2D feature-extraction model 115 may also send data generated based on the 2D features to the estimation-model encoder 120 at operation 22e3.

FIG. 2B is a block diagram depicting a 2D feature-extraction model, according to some embodiments of the present disclosure.

Referring to FIG. 2B, the intermediate-output data IMO may be received by the 2D feature-extraction model 115. The intermediate-output data IMO may be provided as an input to 2D convolutional layers 30 and to an interpolation layer function 33. The 2D convolutional layers 30 may output a predicted attention mask PAM and/or predicted 2D hand-joint or 2D hand-mesh data 31. The predicted 2D hand-joint or 2D hand-mesh data 31 may be sent for concatenation at operations 22e1 and 22e2 (see FIG. 2A). The predicted attention mask PAM may be sent to the estimation-model encoder 120 at operation 22e3 (see FIG. 2A).

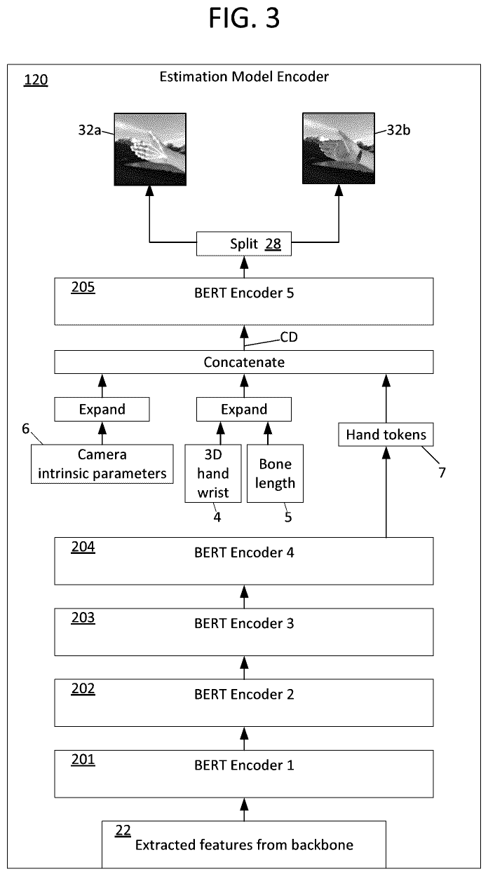

FIG. 3 is a block diagram depicting a structure of an estimation-model encoder of the estimation model, according to some embodiments of the present disclosure.

Referring to FIG. 3, extracted features from the backbone output data 22 may be provided as inputs to a chain of BERT encoders 201-205. For example, one or more features from the backbone output data 22 may be provided as an input to a first BERT encoder 201. In some embodiments, an output of the first BERT encoder 201 may be provided as an input to a second BERT encoder 202; an output of the second BERT encoder 202 may be provided as an input to a third BERT encoder 203; and an output of the third BERT encoder 203 may be provided as an input to a fourth BERT encoder 204. In some embodiments, the output of the fourth BERT encoder 204 may correspond to hand tokens 7. The hand tokens 7 may be concatenated with camera intrinsic-parameter data 6 and/or with 3D hand-wrist data 4 and/or bone-length data 5 to generate concatenated data CD. For example, in some embodiments, the hand tokens 7 may be concatenated with camera intrinsic-parameter data 6 and with either 3D hand-wrist data 4 or bone-length data 5. The camera intrinsic-parameter data 6, the 3D hand-wrist data 4, and the bong-length data 5 may be expanded before being concatenated with the hand tokens 7. The concatenated data CD may be received as an input to a fifth BERT encoder 205. The output of the fifth BERT encoder 205 may be split at operation 28 and provided to the first estimation-model output 32a and to the second estimation-model output 32b. Although the present disclosure refers to five BERT encoders in the chain of BERT encoders. It should be understood that the present disclosure is not limited thereto. For example, more or less than five BERT encoders may be provided in the chain of BERT encoders.

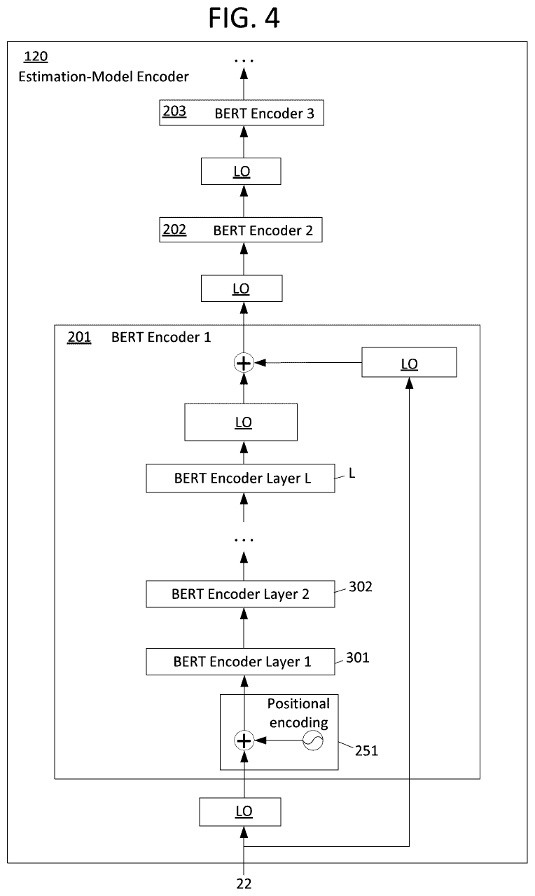

FIG. 4 is a block diagram depicting a structure of a BERT encoder of the estimation-model encoder, according to some embodiments of the present disclosure.

Referring to FIG. 4, one or more BERT encoders of the estimation-model encoder 120 may include one or more encoder layers. For example, the first BERT encoder 201 may have L encoder layers (with L being an integer greater than zero). In some embodiments, L may be greater than four and may result in an estimation-model encoder with greater accuracy than embodiments having four or fewer encoder layers. For example, in some embodiments, L may be equal to 12.

In some embodiments, extracted features from the backbone output data 22 may be provided as inputs to the first encoder layer 301 of the first BERT encoder 201. In some embodiments the extracted features from the backbone output data 22 may be provided as inputs to one or more linear operations LO (operations provided by linear layers) and positional encoding 251 before being provided to the first encoder layer 301. An output of the first encoder layer 301 may be provided to an input of a second encoder layer 302, and an output of the second encoder layer 302 may be provided to an input of a third encoder layer 303. That is, the first BERT encoder 201 may include a chain of encoder layers with L encoder layers total. In some embodiments, an output of the L-th encoder layer may be provided as an input to one or more linear operations LO before being sent to an input of the second BERT encoder 202. As discussed above, the estimation-model encoder 120 may include a chain of BERT encoders (e.g., including the first BERT encoder 201, the second BERT encoder 202, a third BERT encoder 203, etc.). In some embodiments, each BERT encoder in the chain of BERT encoders may include L encoder layers.

FIG. 5A is a block diagram depicting a structure of an encoder layer of the BERT encoder with a pre-sharing weight mechanism, according to some embodiments of the present disclosure.

As an overview, the structure of the estimation-model encoder 120 (see FIG. 4) allows for image features to be concatenated with sampled 3D hand-pose positions and embedded with 3D position embedding. A feature map may be split into a number of tokens. Thereafter, as will be discussed in further detail below, an attention of each hand pose position may be calculated by a pre-sharing weight attention. The feature map may be extended to a number of tokens, where each token may focus on the prediction of one hand-pose position. The tokens may pass a pre-sharing weight attention layer, where the weights of an attention value layer may be different for different tokens. Hand-joint and hand-mesh tokens may then be processed by different graph convolutional networks (GCNs) (also referred to as graph convolutional neural networks (GCNNs)). Each GCN may have different weights for different tokens. The hand-joint tokens and hand-mesh tokens may be concatenated together and processed by a fully convolutional network for 3D hand pose position prediction.

Referring to FIG. 5A, each encoder layer (e.g., the first encoder layer 301) of each BERT encoder (e.g., the first encoder layer 301) may include an attention module 308 (e.g., a multi-head self-attention module), residual networks 340, GCN blocks 350, and a feed forward network 360. The attention module 308 may include an attention mechanism 310 (e.g., a scaled dot-product attention) associated with attention-mechanism inputs 41-43 and attention-mechanism outputs 321. For example, first attention-mechanism inputs 41 may be associated with queries, second attention-mechanism inputs 42 may be associated with keys, and third attention-mechanism inputs 43 may be associated with values. The queries, keys, and values may be associated with input tokens. In some embodiments, and as discussed in further detail below with respect to FIGS. 5B-5D, the third attention-mechanism inputs 43 may be associated with pre-sharing weights for improved accuracy. For example, the pre-sharing weights may correspond to weighted input tokens WIT. In some embodiments, the attention-mechanism outputs 321 may be provided for concatenation at operation 320. An encoder layer output 380 of the first encoder layer 301 may include an output token OT. The output token OT may be calculated, by the first encoder layer 301, based on receiving the weighted input tokens WIT.

The attention mechanism 310 may include a first multiplication function 312, a second multiplication function 318, a scaling function 314, and a softmax function 316. The first attention-mechanism inputs 41 and the second attention-mechanism inputs 42 may be provided to the first multiplication function 312 and the scaling function 314 to produce a normalized score 315. The normalized score 315 and an attention map AM may be provided to the softmax function 316 to produce an attention score 317. The attention score 317 and the third attention-mechanism inputs 43 may be provided to a second multiplication function 318 to produce an attention-mechanism output 321.

FIG. 5B is a diagram depicting full sharing with a same weight applied to different input tokens of the encoder layer of the BERT encoder, according to some embodiments of the present disclosure.

FIG. 5C is a diagram depicting pre-aggregation sharing with different weights applied to different input tokens of the encoder layer of the BERT encoder, according to some embodiments of the present disclosure.

As an overview, FIG. 5C depicts pre-sharing weights of a GCN and a value layer of an attention mechanism (also referred to as an attention block). In a pre-sharing mode, which is different from a full-sharing mode, weights for different tokens (also referred to as nodes) may be different before values are aggregated to the updated tokens (or output tokens). Therefore, different transformations may be applied to the input features of each token before they are aggregated.

FIG. 5D is a diagram depicting hand joints and a hand mesh, according to some embodiments of the present disclosure.

Referring to the hand joint HJ structure of FIG. 5D, in some embodiments, another GCN for hand-joint estimation may be added. The hand-joint structure of FIG. 5D may be used to generate an adjugate matrix in the GCN blocks.

Referring to FIG. 5B-5D, a first input token T1 and a second input token T2 of the estimation-model encoder 120 (see FIG. 1) may be associated with one or more features extracted from the input data 12 (see FIG. 1). In the case of hand-pose estimation, each token may correspond to a different hand joint HJ or to a different hand-mesh vertex HMV (also referred to as a hand-mesh point).

Referring to FIG. 5B, in some embodiments, the attention module 308 (see FIG. 5A) may not include pre-sharing. For example, in some embodiments, the attention module 308 may include full sharing, instead of pre-sharing (also referred to as pre-aggregation sharing as depicted in FIG. 5C). In full sharing, the same weight W may be applied to each input token (e.g., the first input token T1, the second input token T2 and a third input token T3) to calculate each output token (e.g., a first output token T1′, a second output token T2′, and a third output token T3′).

Referring to FIG. 5C, in some embodiments, the attention module 308 (see FIG. 5A) may include pre-sharing. In pre-sharing, different weights may be applied to each input token. For example, a first weight Wa may be applied to the first input token T1 to produce a first-weighted input token WIT1; a second weight Wb may be applied to the second input token T2 to produce a second-weighted input token WIT2; and a third weight We may be applied to a third input token T3 to produce a third-weighted input token WIT3. The weighted input tokens WIT may be received as inputs to the attention module 308. The first encoder layer 301 may calculate the output token OT based on receiving the weighted input tokens WIT as inputs to the attention mechanism 310. The use of different weights in pre-sharing may cause different equations to be used to estimate different hand joints (or hand mesh vertices), which may result in improved accuracy over full sharing approaches.

FIG. 5E is a block diagram depicting a dynamic mask mechanism, according to some embodiments of the present disclosure.

Referring to FIG. 5E, at operation 22e3 (see also FIG. 2A), the estimation-model encoder 120 may be provided with a predicted attention mask PAM from the 2D feature-extraction model 115 (see FIG. 2B). The predicted attention mask PAM may indicate which hand joints HJ or which hand-mesh vertices HMV (see FIG. 5D) are occluded (e.g., covered, obstructed, or hidden from view) in the image data 2 (see FIG. 1). The predicted attention mask PAM may be used by a dynamic mask-updating mechanism 311 of the estimation-model encoder 120 to update the attention map AM used by the attention mechanism 310 to produce a masked attention map MAM. That is, in some embodiments, the dynamic mask-updating mechanism 311 may be used as an extra operation, associated with the attention mechanism 310 discussed above with respect to FIG. 5A, to improve the accuracy of the estimation model 101. By updating the attention map AM to indicated occluded hand joints HJ or hand-mesh vertices HMV, an accuracy of the estimation model 101 may be improved because the masked tokens MT, represented in the predicted attention mask PAM and the masked attention map MAM, may reduce an amount of noise that might otherwise be associated with the occluded hand joints HJ or hand-mesh vertices HMV. In some embodiments, the masked tokens (depicted as shaded squares in the predicted attention mask PAM and in the masked attention map MAM) may be represented by very large values. The predicted attention mask PAM may be updated to produce an updated predicted attention mask PAM′ in subsequent processing cycles. For example, the predicted attention mask PAM may be updated as unobstructed (e.g., non-occluded) hand joints HJ or unobstructed hand-mesh vertices HMV are estimated and used to estimate the occluded hand joints HJ or hand-mesh vertices HMV. In some embodiments, a mesh-adjugate matrix 502 may be used to update the predicted attention mask PAM. For example, a first hand joint HJ (depicted by the number “1” in FIG. 5E) may be obstructed, and a second hand joint HJ (depicted by the number “2” in FIG. 5E) may be unobstructed. The mesh-adjugate matrix 502 may be used to remove the mask associated with the first hand joint HJ because the first hand joint is connected to the second hand joint. Accordingly, the dynamic mask-updating mechanism 311 may enable obstructed hand joints HJ or hand-mesh vertices to be more accurately estimated based on information associated with unobstructed hand joints HJ or hand-mesh vertices.

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as Bluetooth™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type from, the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

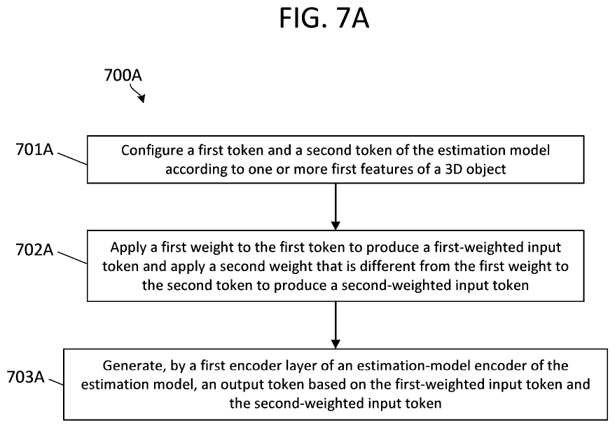

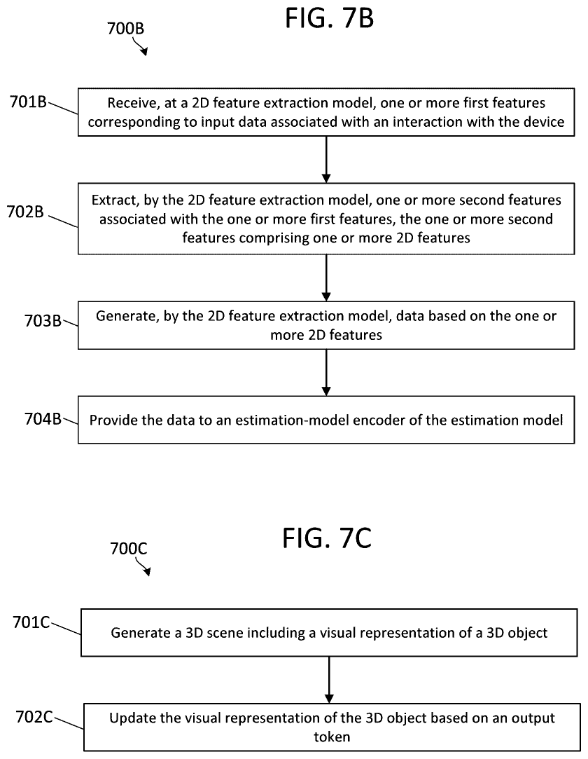

FIG. 7A is a flowchart depicting example operations of a method of estimating an interaction with a device, according to some embodiments of the present disclosure.

Referring to FIG. 7A, a method 700A of estimating an interaction with a device 100 may include one or more of the following operations. An estimation model 101 may configure a first token T1 and a second token T2 of the estimation model 101 according to one or more first features of a 3D object (see FIG. 1 and FIG. 5C) (operation 701A). The estimation model 101 may apply a first weight Wa to the first token T1 to produce a first-weighted input token WIT1 and may apply a second weight Wb that is different from the first weight Wa to the second token T2 to produce a second-weighted input token WIT2 (operation 702A). A first encoder layer 301 of an estimation-model encoder 120 of the estimation model 101 may generate an output token OT based on the first-weighted input token WIT1 and the second-weighted input token WIT2 (operation 703A).

FIG. 7B is a flowchart depicting example operations of a method of estimating an interaction with a device, according to some embodiments of the present disclosure.

Referring to FIG. 7B, a method 700B of estimating an interaction with a device 100 may include one or more of the following operations. A 2D feature-extraction model 115 may receive one or more first features corresponding to input data associated with an interaction with the device from a backbone 110 (operation 701B). The 2D feature-extraction model 115 may extract one or more second features associated with the one or more first features, wherein the one or more second features include one or more 2D features (operation 702B). The 2D feature-extraction model 115 may generate data based on the one or more 2D features (operation 703B). The 2D feature-extraction model 115 may provide the data to an estimation-model encoder 120 of the estimation model 101 (operation 704B).

FIG. 7C is a flowchart depicting example operations of a method of estimating an interaction with a device, according to some embodiments of the present disclosure.

Referring to FIG. 7C, a method 700C of estimating an interaction with a device 100 may include one or more of the following operations. A device 100 may generate a 3D scene including a visual representation of a 3D object (e.g., a body part) associated with an interaction with the device 100 (operation 701C). The device 100 may update the visual representation of the 3D object based on an output token generated by an estimation model 101 associated with the device 100 (operation 702C).

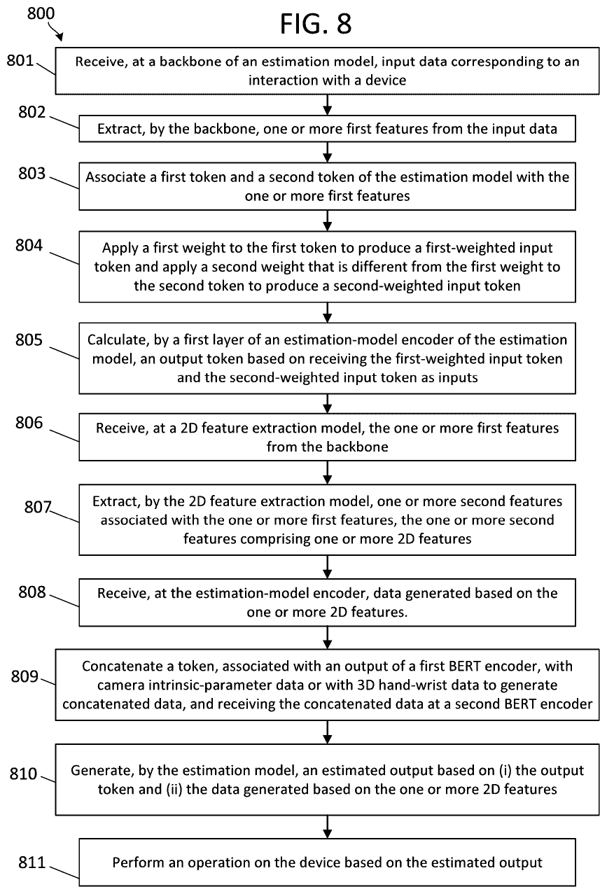

FIG. 8 is a flowchart depicting example operations of a method of estimating an interaction with a device, according to some embodiments of the present disclosure.

Referring to FIG. 8, a method 800 of estimating an interaction with a device 100 may include one or more of the following operations. A backbone 110 of an estimation model 101 may receive input data 12 corresponding to an interaction with the device 100 (operation 801). The backbone 110 may extract one or more first features from the input data 12 (operation 802). The estimation model 101 may associate a first token T1 and a second token T2 of the estimation model 101 with the one or more first features (see FIG. 1 and FIG. 5C) (operation 803). The estimation model 101 may apply a first weight Wa to the first token T1 to produce a first-weighted input token WIT1 and may apply a second weight Wb that is different from the first weight Wa to the second token T2 to produce a second-weighted input token WIT2 (operation 804). A first encoder layer 301 of an estimation-model encoder 120 of the estimation model 101 may calculate an output token OT based on receiving the first-weighted input token WIT1 and the second-weighted input token WIT2 as inputs (operation 805). A 2D feature-extraction model 115 may receive the one or more first features from the backbone 110 (operation 806). The 2D feature-extraction model 115 may extract one or more second features associated with the one or more first features, wherein the one or more second features include one or more 2D features (operation 807). The estimation-model encoder 120 may receive data generated based on the one or more 2D features (operation 808). The estimation model may concatenate a token, associated with an output of a first BERT encoder, with camera intrinsic-parameter data or with 3D hand-wrist data to generate concatenated data, and receive the concatenated data at a second BERT encoder (operation 809). The estimation model 101 may generate an estimated output 32 based on the output token OT and the data generated based on the one or more 2D features (operation 810). The estimation model 101 may cause an operation to be performed on the device 100 based on the estimated output 32 (operation 811).

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of estimating an interaction with a device, the method comprising:
configuring a first token and a second token of an estimation model according to one or more first features of a 3-dimensional (3D) object;
applying a first weight to the first token to produce a first-weighted input token and applying a second weight that is different from the first weight to the second token to produce a second-weighted input token; and
generating, by a first encoder layer of an estimation-model encoder of the estimation model, an output token based on the first-weighted input token and the second-weighted input token.

2. The method of claim 1, further comprising:
receiving, at a backbone of the estimation model, input data corresponding to the interaction with the device;
extracting, by the backbone, the one or more first features from the input data;
receiving, at a two-dimensional (2D) feature extraction model, the one or more first features from the backbone;
extracting, by the 2D feature extraction model, one or more second features associated with the one or more first features, the one or more second features comprising one or more 2D features;
receiving, at the estimation-model encoder, data generated based on the one or more 2D features;
generating, by the estimation model, an estimated output based on the output token and the data generated based on the one or more 2D features; and
performing an operation based on the estimated output.

3. The method of claim 2, wherein the data generated based on the one or more 2D features comprises an attention mask.

4. The method of claim 1, wherein the first encoder layer of the estimation-model encoder corresponds to a first BERT encoder of the estimation-model encoder, and the method further comprises:
concatenating a token, associated with an output of the first BERT encoder, with at least one of camera intrinsic-parameter data, three-dimensional (3D) hand-wrist data, or bone-length data to generate concatenated data; and
receiving the concatenated data at a second BERT encoder.

5. The method of claim 4, wherein:
the first BERT encoder and the second BERT encoder are included in a chain of BERT encoders, the first BERT encoder and the second BERT encoder being separated by at least three BERT encoders of the chain of BERT encoders; and
the chain of BERT encoders comprises at least one BERT encoder having more than four encoder layers.

6. The method of claim 1, wherein:
a data set used to train the estimation model is generated based on two-dimensional (2D) image rotation and rescaling that is projected to three dimensions (3D) in an augmentation process; and
a backbone of the estimation model is trained using two optimizers.

7. The method of claim 1, wherein:
the device is a mobile device;
the interaction is a hand pose; and
the estimation model comprises hyperparameters comprising at least one of:
an input feature dimension that is about equal to 1003/256/128/32 for estimating 195 hand-mesh points;
an input feature dimension that is about equal to 2029/256/128/64/32/16 for estimating 21 hand joints;
a hidden feature dimension that is about equal to 512/128/64/16 (4H, 4L) for estimating 195 hand-mesh points; or
a hidden feature dimension that is about equal to 512/256/128/64/32/16 (4H, (1, 1, 1, 2, 2, 2)L) for estimating 21 hand joints.

8. The method of claim 1, further comprising:
generating a 3D scene including a visual representation of the 3D object; and
updating the visual representation of the 3D object based on the output token.

9. A method of estimating an interaction with a device, the method comprising:
receiving, at a two-dimensional (2D) feature extraction model of an estimation model, one or more first features corresponding to input data associated with an interaction with the device;
extracting, by the 2D feature extraction model, one or more second features associated with the one or more first features, the one or more second features comprising one or more 2D features;
generating, by the 2D feature extraction model, data based on the one or more 2D features; and
providing the data to an estimation-model encoder of the estimation model.

10. The method of claim 9, further comprising:
receiving, at a backbone of the estimation model, the input data;
generating, by the backbone, the one or more first features based on the input data;
associating a first token and a second token of the estimation model with the one or more first features;
applying a first weight to the first token to produce a first-weighted input token and applying a second weight that is different from the first weight to the second token to produce a second-weighted input token;
calculating, by a first encoder layer of the estimation-model encoder, an output token based on receiving the first-weighted input token and the second-weighted input token as inputs; and
generating, by the estimation model, an estimated output based on the output token and the data generated based on the one or more 2D features; and
performing an operation based on the estimated output.

11. The method of claim 9, wherein the data generated based on the one or more 2D features comprises an attention mask.

12. The method of claim 9, wherein the estimation-model encoder comprises a first BERT encoder comprising a first encoder layer, and the method further comprises:
concatenating a token, corresponding to an output of the first BERT encoder, with at least one of camera intrinsic-parameter data, three-dimensional (3D) hand-wrist data, or bone-length data to generate concatenated data; and
receiving the concatenated data at a second BERT encoder.

13. The method of claim 12, wherein:
the first BERT encoder and the second BERT encoder are included in a chain of BERT encoders, the first BERT encoder and the second BERT encoder being separated by at least three BERT encoders of the chain of BERT encoders; and
the chain of BERT encoder comprises at least one BERT encoder having more than four encoder layers.

14. The method of claim 9, wherein:
a data set used to train the estimation model is generated based on 2D-image rotation and rescaling that is projected to three dimensions (3D) in an augmentation process; and
a backbone of the estimation model is trained using two optimizers.

15. The method of claim 9, wherein:
the device is a mobile device;
the interaction is a hand pose; and
the estimation model comprises hyperparameters comprising at least one of:
an input feature dimension that is about equal to 1003/256/128/32 for estimating 195 hand-mesh points;
an input feature dimension that is about equal to 2029/256/128/64/32/16 for estimating 21 hand joints;
a hidden feature dimension that is about equal to 512/128/64/16 (4H, 4L) for estimating 195 hand-mesh points; or
a hidden feature dimension that is about equal to 512/256/128/64/32/16 (4H, (1, 1, 1, 2, 2, 2)L) for estimating 21 hand joints.

16. The method of claim 9, further comprising:
calculating, by a first encoder layer of the estimation-model encoder, an output token;
generating a 3D scene including a visual representation of the interaction with the device; and
updating the visual representation of the interaction with the device based on the output token.

17. A device configured to estimate an interaction with the device, the device comprising:
a memory; and
a processor communicably coupled to the memory, wherein the processor is configured to:
receive, at a two-dimensional (2D) feature extraction model of an estimation model, one or more first features corresponding to input data associated with an interaction with the device;
generate, by the 2D feature extraction model, one or more second features based on the one or more first features, the one or more second features comprising one or more 2D features; and
send, by the 2D feature extraction model, data generated based on the one or more 2D features to an estimation-model encoder of the estimation model.

18. The device of claim 17, wherein the processor is configured to:
receive, at a backbone of the estimation model, the input data;
generate, by the backbone, the one or more first features based on the input data;
associate a first token and a second token of the estimation model with the one or more first features;
apply a first weight to the first token to produce a first-weighted input token and applying a second weight that is different from the first weight to the second token to produce a second-weighted input token;
calculate, by a first encoder layer of the estimation-model encoder, an output token based on receiving the first-weighted input token and the second-weighted input token as inputs;
generate, by the estimation model, an estimated output based on the output token and the data generated based on the one or more 2D features; and
perform an operation based on the estimated output.

19. The device of claim 17, wherein the data generated based on the one or more 2D features comprises an attention mask.

20. The device of claim 17, wherein the estimation-model encoder comprises a first BERT encoder comprising a first encoder layer, and the processor is configured to:
concatenate a token, corresponding to an output of the first BERT encoder, with at least one of camera intrinsic-parameter data, three-dimensional (3D) hand-wrist data, or bone-length data to generate concatenated data; and
receive the concatenated data at a second BERT encoder.
